(19) United States
(12) Patent Application Publication
(10) Pub. No.: US 2004/0198397 A1
(43) Pub. Date: Oct. 7, 2004

(54) Method and device for handling location-based services

(76) Inventor: Peter Weiss, Wien (AT)

Correspondence Address: LERNER AND GREENBERG, P.A., POST OFFICE BOX 2480, HOLLYWOOD, FL, 33022-2480, US

(21) Appl. No.: 10/768,885

(22) Filed: Jan. 30, 2004

(30) Foreign Application Priority Data
Apr. 2, 2003 (DE) 103 15 064.1

(51) Int. Cl. H04M 1/00

(52) U.S. Cl. 455/456.5; 455/456.1

(57) ABSTRACT

A location-based service is handled for a limited geographic area for a plurality of subscribers in this geographic area. The area is served by more than one device for determining the geographic position of mobile radio users. The location-based service sends an inquiry about the identity of subscribers in the geographic area to a central network element, whereupon the central network element, instead of the location-based service, requests the current information about the subscribers active in the limited geographic area from the at least two devices for determining the geographic position of mobile radio users. The central network element then delivers the result back to the location-based service.

### BACKGROUND OF THE INVENTION

### Field of the Invention

The invention relates to a method for location-based services. The invention also relates to a device for carrying out the method according to the invention. The invention finds its most advantageous application in wireless radio systems.

Current services are closely tied to particular networks; subscribers use codes which specify these networks. Most of these networks allow roaming in other access networks and subscribers have the option of using more than one network, for example by means of a multimode terminal or also via different terminals. On the other hand, various application servers offer interesting services. These should be independent of the basic network and the changing network provider. The trend is toward international service providers who do not want to be impaired by local circumstances. It would be advantageous, therefore, to be able to provide a server which can hide these differences.

Location-based services currently being offered allow a subscriber to be located. Services which want to deal with more than one subscriber, for example, different “identities” of a person, or unknown identities in a particular area independently of the network used need a current database with a multiplicity of information items about the networks and the regions covered by the networks.

Current 3GPP (3rd Generation Partnership Project, www.3gpp.org) protocols are oriented towards location-based services that handle few subscribers. Services which should cover all registered subscribers, for example, statistical analyses with a detailed local accuracy or services limited to particular, relatively small regions, produce a large amount of signaling messages and thus trigger many locating processes. Furthermore, the implementation is not set up for a higher density of interrogation with respect to privacy concerns and the protection of the privacy sphere.

Examples of services affected by this are:

emergency information for a district: for example closing a park, fire alarm, warning against hazards

advertisements for a region: opening of a new business, beginning of an event in a few minutes . . .

triggering of a service when the user enters a particular area: e.g. offering special information, changing to a better (or more advantageous) connection such as WLAN, Bluetooth, etc.

triggering of a service when the user remains at the same place for a particular period: e.g. queuing at a check-out or in front of an entrance, looking at an advertisement (poster), waiting at a stop . . .

the user can be informed when he approaches a particular place, for example a restaurant or a hotel

the user is informed when he approaches a particular other user or a device: friend, colleague, team-mate, parking ticket dispenser . . .

the user is informed when a person or device is leaving a region: theft protection, child leaving party, etc.

location-dependent charging: in particular, the subscriber must be informed that the charging changes when he leaves or enters a region

statistical analyses such as determination of the number of devices in a region, for example, for detecting a traffic jam, responding to the increased demand for public transport after the end of a mass event such as a concert, a sports event, etc.

To date, location-dependent services are still in the introductory phase and are therefore not used particularly frequently. Many of the services specified above have not yet been implemented or can only be implemented with poor resolution on the basis of information currently available in a network such as the cellID (identification of a cell of a cellular network) or LAC (location area code—a larger location area formed of cells). In the near future, only network-specific services will be offered and an open interface is currently not provided. OMA/LIF (Open Mobile Alliance, Location Interoperability Forum, www.openmobilealliance.org) and 3GPP are only beginning to define the extensions for location-dependent triggering.

Furthermore, the demand for internetwork services does not yet exist to a great extent since there are currently only a few subscribers who use different access networks side-by-side. However, it is already apparent that, for example, an alternative utilization of GPRS (General Packet Radio Services) and WLAN (Wireless Local Area Network) is becoming more and more popular.

Hitherto conceivable solutions would be:

cyclic polling of the terminals. However, since this can involve a large number of devices, a high data flow is generated

involving all subscribers such as broadcast SMS. No special selection of subscribers for one service possible (e.g. only foreign subscribers).

### SUMMARY OF THE INVENTION

It is accordingly an object of the invention to provide a method and a device for supporting location-based services which overcome the above-mentioned disadvantages of the heretofore-known devices and methods of this general type and which specify a solution for an improved offering of location-dependent services.

With the foregoing and other objects in view there is provided, in accordance with the invention, a method for handling a location-based service in a limited geographic area for a plurality of subscribers, wherein the limited geographic area is served by at least two devices for determining a geographic position of mobile radio users, the method which comprises:

receiving, in a central network element, an inquiry from the location-based service concerning an identity of the subscribers in the limited geographic area;

requesting, with the central network element, a current information item about the subscribers active in the limited geographic area from the at least two devices for determining the geographic position of mobile radio users; and

delivering, with the central network element, the information to the location-based service.

In other words, the invention relates to a method for handling a location-based service for a limited geographic area (also referred to as “area” in the text which follows) which is served by at least two devices for determining the geographic position of mobile radio users (GMLC) for a plurality of subscribers in this geographic area.

The location-based service (LCS) sends an inquiry about the identity of subscribers in a geographic area (area) to a central network element (LAS1). The central network element then obtains the current information about the subscribers active in the limited geographic area from the at least two devices for determining the geographic position of mobile radio users (GMLC). The central network element then delivers the result back to the location-based service (LCS).

In the solution according to the invention, the freely selectable region is not restricted to one network operator. The external location services (LCS) client no longer needs to distribute the inquiry to all network operators offering their services in this area, this is done for it by the central network element. As long as 3GPP networks are involved, this is a relatively small problem since there is only a small number of these and they are generally known. In the case of the WLAN networks, however, the situation is different since this is a rapidly changing business.

An additional network node is then introduced which contains all network operators and their local radius of operation. The central network element which deals with the interaction of the network operators provides third-party service providers with the opportunity to offer their own small applications inexpensively and rapidly. End users, network operators and application developers will profit from such an approach.

The distribution, carried out by the central network element, of functionalities to many connected network nodes which are controlled by different operators supports third-party service providers in offering their services also in areas which are made difficult by technological, administrative or legal boundaries.

These central network elements also solve dynamic problems by reducing the network load and using caches.

In accordance with an added feature of the invention, a first device for determining the geographic position of mobile radio users is located within an infrastructure of a first mobile radio network and a second device for determining the geographic position of mobile radio users is located within an infrastructure of a second mobile radio network.

In accordance with an additional feature of the invention, upon receiving an inquiry in the central network element, a check is carried out whether a desired result is already stored as a result of a previous inquiry and the result can be delivered to the location-based service, or the central network element must request the desired result from the at least one device for determining the geographic position of mobile radio users. The process may further provide a result requested by the central network element from a device for determining the geographic position of mobile radio users with an additional identification (e.g., a timestamp and/or information on an accuracy of the inquiry), and reuse the stored result for one or more further inquiries in dependence on the additional identification.

In accordance with another feature of the invention, the method comprises, upon receiving an inquiry in the central network element, first checking whether a desired inquiry has already been processed or a result of a previous inquiry is still outstanding, and, after receiving the result of the previous inquiry, a current inquiry can also be answered.

In accordance with a further feature of the invention, the central network element collects the results of the inquiries from the at least two devices for determining the geographic position of mobile radio users and, as soon as all interrogated devices for determining the geographic position of mobile radio users have answered, combines the answers and to deliver the result to the location-based service.

In accordance with again an added feature of the invention, the region of the inquiry comprises a first geographic region (location area 1) for which a first central network element is responsible, and comprises a second geographic region (location area 2) for which a second central network element is responsible. Furthermore, the first central network element receives an inquiry and forwards this inquiry for the second geographic region to the second central network element.

In accordance with again an additional feature of the invention, the central network element stores the results of the inquiries as a list and only delivers the identification of the list back to the location-based service. Preferably, the central network element is additionally supplied with or determines by other means characteristics of the subscribers determined from the devices for determining the geographic position of mobile radio users, collects these and stores them for later use, and delivers them back to the location-based service together with the identification of the list.

In accordance with again a further feature of the invention, the central network element contains a correlation between the identity of at least one subscriber for whom a location information is requested and the network node responsible for this subscriber and, if the central network element receives an inquiry message from the location-based service, it distributes this inquiry to each identity which is stored for this network node.

With the above and other objects in view there is also provided, in accordance with the invention, a device for handling inquiries of a location-based service, for a limited geographic area (area) which is served by at least two devices for determining the geographic position of mobile radio users, for a plurality of subscribers in this geographic area. The novel device includes:

means for receiving inquiries, sent by the location-based service, about the identity of subscribers in this geographic area; and

means for sending a request for current information about the subscribers active in the limited geographic area to a device for determining the geographic position of mobile radio users; and

means for receiving the answers from the interrogated device for determining the geographic position of mobile radio users; and

means for processing the answers; and

means for sending the result to the location-based service.

In accordance with yet an added feature of the invention, the device has a database for storing the answers from the interrogated device for determining the geographic position of mobile radio users and an additional identification of the answers, and means for comparing a new inquiry with the answers already stored.

In accordance with a concomitant feature of the invention, the database stores the answers from the interrogated device for determining the geographic position of mobile radio users and sends an unambiguous identification (unique identifier) of the answers, and the unambiguous identification of the answers is used in subsequent messages from the location-based service.

Other features which are considered as characteristic for the invention are set forth in the appended claims.

Although the invention is illustrated and described herein as embodied in a method and a device for handling location-based services, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of an existing 3GPP network architecture supplemented in accordance with the invention;

FIG. 2 is an architecture diagram with the local area server LAS;

FIG. 3 is an area diagram showing various geographic areas which are supplied by an LAS;

FIG. 4 is a tree structure showing a geographic area covered by a local area server LAS;

FIG. 5 is an area diagram showing an example of various independent requirements; and

FIG. 6 is a data exchange flowchart.

### DESCRIPTION OF THE PREFERRED EMBODIMENTS

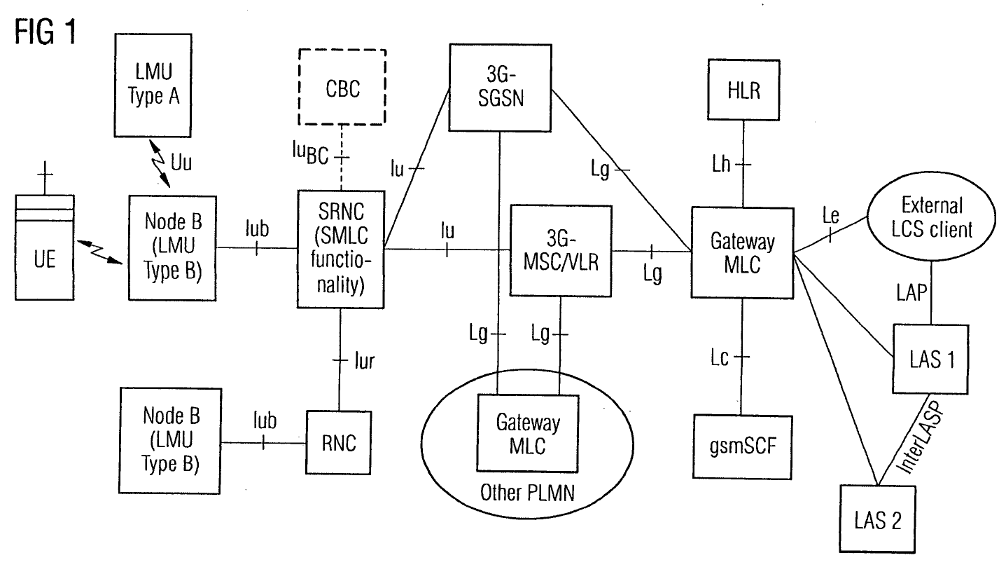

Referring now to the figures of the drawing in detail and first, particularly, to FIG. 1 thereof, there is illustrated a block diagram showing a basic structure of the architecture of the system.

A. Architecture and Overview

FIG. 1 shows the current 3GPP network architecture as depicted in chapter 5.2.2 of the specification 3GPP TS 23.002 (V5.9.0, 2002-12): Network Architecture. A more detailed description of the network elements and interfaces (Lh, Le, Lc, Lg, Iu, Iur, Iub, Uu, etc.) can also be found there; for that purpose, the specification is herewith incorporated by reference.

In the home location register HLR, entries with respect to subscriber information are assigned to the mobile radio subscriber.

The visitor location register VLR is the local register for switching-based services. It is used by the mobile switching center MSC for obtaining information about roaming subscribers, that is to say those from local and other mobile radio operators, staying in the region and for processing their calls.

In contrast, the serving GPRS support node SGSN, is needed for storing subscriber information for packet-oriented services in a mobile radio network.

The mobile-services switching center MSC also represents the interface between the mobile radio network and the landline network. The switching center performs all necessary functions for processing circuit-switched services to and from the mobile station.

The gateway mobile location center GMLC is the first network node accessed via a location-based service in a mobile radio network. It performs the authorization and interrogates the home location register HLR for the routing information.

In the text which follows, GMLC also stands for other network nodes such as WLAN access points (also called hotspots), landline network, etc., which form the access for location-based services.

A node B is a logical network component which serves one or more cells. A radio network controller RNC is a network component in the mobile radio network which controls one or more nodes B.

The location measurement unit LMU performs radio measurements in support of locating methods. Two types of LMU are defined, namely:

type A: access via the normal GSM interface (Uₘ), there is no wire connection to another network element.

type B: access via the base station—controller interface (I_{UB}). The LMU can be a stand-alone network element with a pseudo-cell ID or can be integrated in a node B.

The serving radio network controller SRNC coordinates the location inquiries as a function of priority and selects a suitable locating method. It can have an interface to the controlling radio network controller CRNC which mainly has aids for locating the terminal and interrogates a corresponding measurement from the network nodes B and LMU.

A description of locating methods may be found, by way of example, in the article “Convex Position Estimation in Wireless Sensor Networks” by Lance Doherty, Kristofer S. J. Pister, Laufent El Ghaoui, Infocom 2001, Anchorage, Ak., April 2001 (http://wwwbsac.eecs.berkeley.edu/-ldoherty/infocom.pdf).

The GSM service control function, gsmSCF, is a functional unit which contains the CAMEL service logic for implementing operator-specific services.

The cell broadcast center CBC is responsible for managing CBS (cell broadcast service) messages and conveying CBS messages to the RNS (Radio Network System).

Only the right-hand part of FIG. 1 is relevant for the present case. An external LCS client interrogates the network for location information via an Lₑ interface (3GPP uses the mobile location protocol MLP (LIF/OMA, TS 101 specification: MLP Mobile Location Protocol). The position can be interrogated with defined accuracy for one or more IDs. However, the protocol can only handle a network which was selected by the external LCS client with the aid of the subscriber ID. In future, this protocol should also be applicable to international cases.

A new network element, the location area server LAS, and a new protocol, the location area protocol LAP for handling areas, are being introduced. The location area server is located between or next to the external LCS client and the various networks.

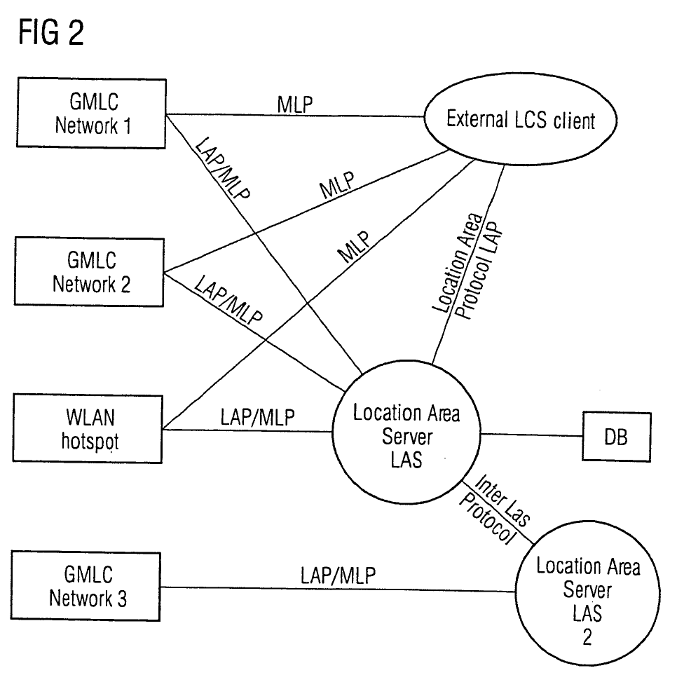

FIG. 2 shows the new network element location area server LAS and its position in the network. The various mobile radio or WLAN operators can cooperate and use the network element LAS for relieving their own network elements and to integrate various technologies. On the other hand, the LAS can join competing networks and allow external applications to gain access to these networks. The LAS has a database which stores the actual network coverage. Each LAS is responsible for a certain region. The region served by an LAS can be a country, a continent or also a relatively small unit. Furthermore, there is an interLAS protocol between two LASs and a mechanism for selecting the correct LAS. The inquiries received by an external LCS client are not limited to the region covered by a single LAS. Communication with the external LCS client takes place via the location area protocol LAP. This can also be used for communicating with the network nodes GLMC or WLAN hotspot. Existing standard protocols are also possible but the losses in functionality must be accepted.

Step 0

The prerequisite is the configuration of the LAS. Each LAS contains a table containing addresses of network nodes and of location areas served by the LAS. These entries can be entered statically, for example by an operator, or generated dynamically by a protocol similar to that described in step 1.

Step 1

The location area data in the LAS must be dynamically updated. As soon as a new network node offers its services or the topology changes, this network node informs the next LAS about the new area served. For this purpose, it sends a message

LAP:UPDATE_LOCATION_AREA

to the LAS with added or removed regions, specified, e.g. by a list of coordinates as described, for example, in the MLP protocol. The network node identifier, the address of the network node and the area served are stored there. If the entire area or a part of it is also served by one or more additional LASs, the message is also forwarded to these LASs. The addresses of these additional LASs, together with the network node identifier, are stored for further actions.

As soon as the LAS receives a timeout during the transmission of messages to network units, it marks the network as “unavailable” in order to keep its database updated. The LAS forwards this information to all additional LASs affected by the failure of this network unit.

To avoid unnecessary messages, each network node should inform the LAS about whether it is available. For this purpose, a message

LAP:OPERATIONAL_AGAIN

is sent to the LAS after a failure.

This mechanism also solves the problem of redundant network elements. If network 1 uses two GMLCs for serving the same area, the two can inform the LAS about the area. The LAS will continue the operation by duplicating all inquiries until one of the GMLCs no longer answers. As soon as the GMLC is operational again, it reports to the LAS and receives copies of the messages again.

Step 2

When the LAS receives the message

LAP:AREA_REQUEST

from an external LCS client, which contains a definition of an area, the LAS checks the area and its responsibility. For the parts of the area administered by other LASs it forwards the inquiries to these LASs. For the part of the area administered by itself, it begins to determine all involved network nodes and their relevant areas.

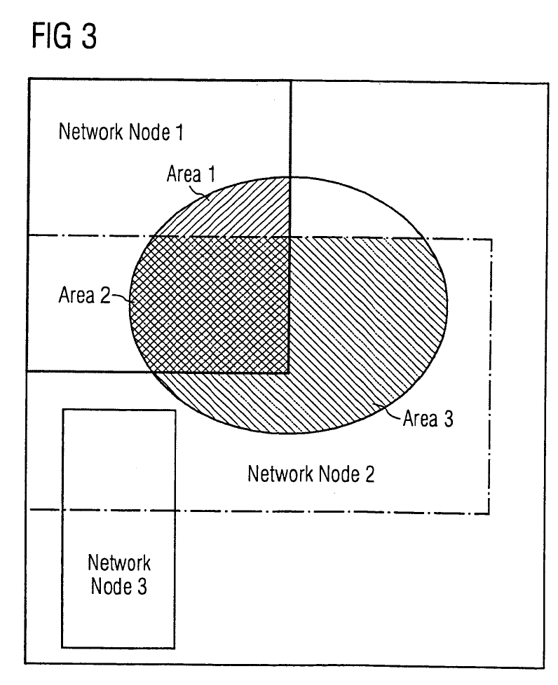

FIG. 3 shows an example of the area served by an LAS. Three network nodes, namely network node [1, 2, 3], have announced the areas served by them (represented, for simplicity, as rectangles). The desired area (an ellipse) is then scanned and split into three areas, namely area [1, 2, 3]. New subareas are formed: subarea 1 consisting of area1 and area2 is used for the network node 1 and subarea 2 consisting of area2 and area3 is used for the network node 2. The network node 3 is not affected by this inquiry.

Step 3

The inquiry received is now forwarded to all selected network nodes, containing only the required subareas. The answers received are routed to the triggering external LCS client, either collected by all network nodes or individually as soon as they arrive depending on the specification in the original inquiry. If a network node does not answer, it is placed in the list of unavailable network nodes (see step 1).

B. Identification

All known protocols inquiring location information such as the MLP (LIF/OMA) need the identity of the subscriber for whom the location information is interrogated. The identity information is available in a variety of formats depending on the technologies used. For example, an Internet address (IP V.4 or IP V.6) looks different from an E.164 number. External LCS clients should not be confronted by these different formats and the LAS advantageously handles the resolution.

For interrogated areas, the external LCS client normally does not know the identities of the subscribers. Naturally, it would be best if the network were to solve this problem and provide a protocol which also allows a location interrogation in the case of unknown identity. However, this would also raise a number of concerns with regard to protection of the private sphere if all external LCS clients were allowed to trace the subscribers of a network. In addition, it would lead to large messages with long lists of subscribers. Even if no return of identities were demanded in the inquiry, the answer would have to contain a list of all subscribers with some identification and location and also a list of the subscribers for whom the inquiry was not successful, either because the wanted subscriber is absent or his data protection rules did not allow an inquiry by this external LCS client.

This problem could be solved by a network node operated in a confidential environment, either due to legal authorization or by the network operator himself.

The LAS contains a database which contains the correlation between identities and the responsible network nodes.

Step 1

The network nodes update the database in the LAS at intervals with all identities currently served by them, with the aid of

LAP: UPDATE_IDENTITIES.

Step 2

When the LAS receives an inquiry message from the external LCS client

LAP: AREA_REQUESTS

it distributes this inquiry to each identity stored in its database for these network nodes.

Step 3

All successful answers

LAP: AREA_REQUEST_RESP

from subscribers located in this area are forwarded to the external LCS client, either collectively or individually, depending on the requested mode. This relieves the external location service client, it does not receive any nonrelevant information, for example about subscribers who are not located within the requested area but who do exist in the network.

If the protocol used between LAS and GMLC (e.g. MLP) does not allow an area to be specified with sufficient accuracy, the position of each subscriber must be interrogated individually and only those who are located within the desired area are reported back.

This procedure is of advantage since the number of inquiries to the area is reduced if only active identities are used. The LCS client does not need to know anything about the internal structure of the identities and the size and number of messages is reduced. The data protection of subscribers who are not interrogated is also guaranteed in this way since no data are sent from the LAS to the LCS client.

However, the network must report all subscribers to the LAS. During this process, internal data are forwarded, and the frequency of use. To solve this data protection problem, LASs can be cascaded. One is located in the network of the operator and receives the message

LAP:UPDATE_IDENTITIES

and a further LAS links various networks but does not receive any information about identities.

Advantageous embodiments are possible:

Variant A

For network nodes serving a large area, it may be advantageous to insert into the message LAP:UPDATE_IDENTITIES specific location information, for example the 3GPP location area. The number of LAP:UPDATE_IDENTITIES messages will increase but the LAS can then only use identities in the requested areas and thus reduce the number of messages to the respective network.

Modified Step 1

The LAS has received internal rules for constructing identities in dependence on each network used, either predefined or with the message

LAP: UPDATE_LOCATION_AREA

from the GMLC. It then generates each possible identifier or uses wild card mechanisms which are allowed by this network for communicating a message (for example “MLP: Triggered Location Reporting Request”) which triggers a return message if the object is registering in the network. If it receives such a report and this report indicates that the subscriber is available, it can set a periodic trigger for receiving the location-based information with somewhat better accuracy, for example in location areas. Using this standard protocol mechanism, the LAS can fill its database consisting of identities, network nodes and known location information without requiring any change in the network.

Variant B

There is a number of applications in which the external LCS client does not need to know the identity of the object located. It can be sufficient to send an information item to all objects located. In this case, a relatively small modification of the protocol is also sufficient for solving this problem:

Modified step 3

On receipt of the answers

LAP: AREA_REQUEST_RESP

in the requested areas, the LAS collects all identities together with capabilities and characteristics of terminals used and possibly identifiers for these (for example SMS, WAP, SIP, E-mail addresses, voice mail, speech . . .). These possibilities and presettings can also be retrieved by the LAS directly from a server keeping these data. A temporary identifier for this list of identities is then sent back to the external LCS client together with statistical information, for example how many subscribers were found, how many of these can use SMS etc.

Step 4

The external LCS client can then address particular parts of the information, for example a web address, a telephone number, a short message or the like to this temporary list by using the message

LAP: SUBMIT_INFO.

The LAS can forward this information to all subscribers of this temporary list in accordance with the user profiles stored by it.

Many of the algorithms described can also be performed by the external LCS client itself. However, since there is a number of independent external LCS clients in the network, it would greatly increase the network loading by means of a multiplicity of messages. It is advantageous, therefore, to introduce a central network node which is conducted by a reliable confidential operator. Thus, the networks of various network operators and various technologies can also be combined in a simple manner.

C. Dynamic Optimization with AREA_IDENTITY

The areas used by applications are normally symbolically defined, for example a country, a city, a building or a shopping mall. Naturally, these areas can be represented by a polygon which consists of a number of points and edges, see, for example, specification LIF TS 101. It is no problem to calculate whether the position of a sought object is located within a sought polygon. However, this requires an increased computational overhead, especially if it is intended to determine whether the object is crossing a boundary. This requires these calculations to be carried out frequently for a high number of possible objects and for all areas checked which exceeds the limits of performance of current network elements. It is therefore desirable not to calculate such an area in polygons but to define it in other network-specific areas. This can be a subnetwork in the case of WLAN or location areas (LAC) and cells (CI) for 3GPP.

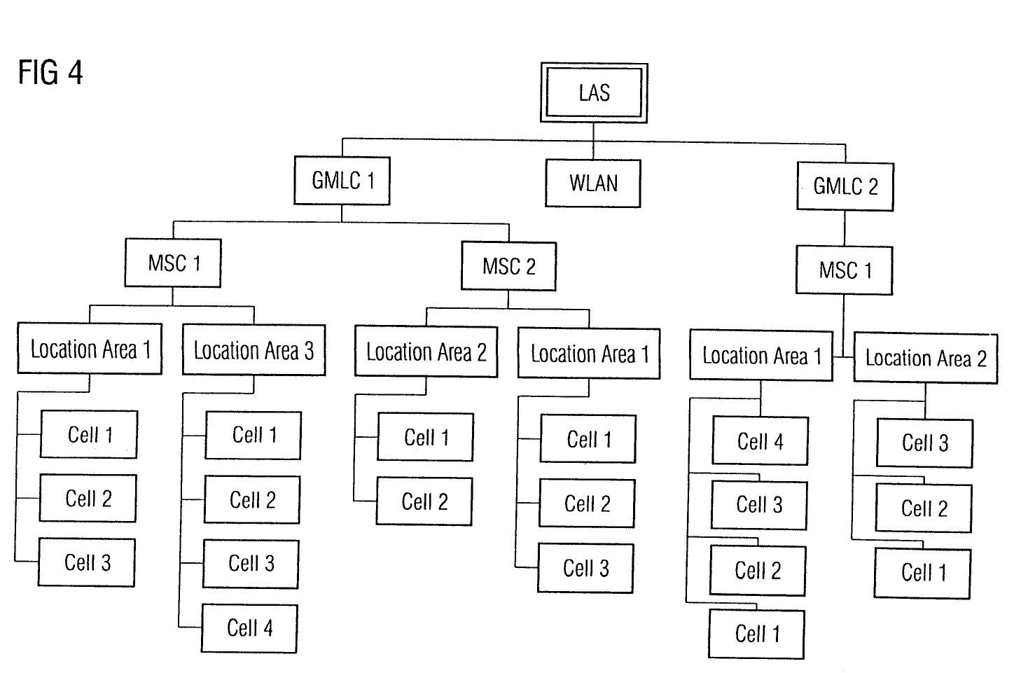

FIG. 4 shows the geographic structure served by an LAS. Its area of responsibility consists of one WLAN and two GMLCs. The GMLC areas, in turn, are covered by one or more MSC-SGSNs. These, in turn, are divided into location areas and the location areas consist of radio cells. Cellular networks are usually built up in such a hierarchical structure. For example, 3GPP is defined in such a manner that an HLR knows the MSC area of a subscriber in which it is currently located. The MSC always knows the last location area of a subscriber. It is only in some cases, for example when a subscriber is currently calling, that the actual cell is known. Otherwise, the precise position of location can only be found by an explicit inquiry from the radio network or from the subscriber station.

An algorithm for avoiding repeated pollings of the position could look as follows: in the first approximation, a set of location areas LA enclosing the desired area is triggered. If the target object is located in one of these location areas, a locating method with more detailed accuracy can be used, for example on the basis of the radio cells. A more detailed determination may be unnecessary if the required accuracy is not very high or the radio cells are small.

To use the mechanism according to the invention, the desired area given by polygons or a composition of ellipses and rectangles must be converted into location areas. The processing necessary for this can be quite elaborate depending on the size of the area and should be avoided. Changes in network topology should also remain unnoticeable for the external LCS client and be transparent.

In the text which follows, a process is thus specified which shows how a desired area is converted once by the LAS and an identifier for this area is delivered back to the external LCS for further use. However, this requires the disclosure of the position of the location areas in the network. This may present problems since network operators may not wish to disclose the internal structure of their network.

The further action by the LAS depends on the user structure, whether the LAS belongs to a network operator or acts across network operators. If the LAS belongs to a number of network operators, a cascaded structure as described above can be advantageously chosen. The external client then sends its inquiry to an LAS belonging to a number of network operators and behaving in accordance with algorithm A. After that, this LAS sends the inquiry to the LASs within the network operator according to algorithm B.

Algorithm A—The LAS does not know the internal structure of the network:

Step 1

The external client sends a message

LAP: REQUEST_AREA_IDENTIFIER

to the LAS. This message contains the complete definition of an area.

Step 2

The LAS processes this area as already described in part A, step 2. During this process, the message

LAP: REQUEST_AREA_IDENTIFIER is forwarded to other LASs if necessary. The result is stored in the database. It consists of a list of units affected and the subareas for these units together with the received identifiers of other LASs. In the case of changes in the network as described in part A, step 1, the data are updated. Since this updating is necessary only sporadically, a gain in performance can be expected, in any case.

Step 3

The LAS stores the definition of the area together with the result obtained, generates an unambiguous name AREA_IDENTITY and sends it back with the message

LAP: REQUEST_AREA_IDENTIFIER_RESPONSE.

In the further course of the action, this identifier can be used for external clients and also by other applications having knowledge of it. Further mechanisms for maintaining these identifiers, for example discarding the entry if it is not used within a number of days or forming the checksum are necessary and known to a person skilled in the art. It can also obtain additional information, for example a readable designator which describes the nature of this area such as “shopping center XY” or “city AZ”. If the requested area is already contained in the database of the LAS, the stored identifier AREA_IDENTITY is delivered back. Advantageously, identifiers already determined by the LAS operator are predefined, for example cities or countries.

Step 4

The AREA_IDENTITY determined or defined can then be used for messages such as LAP: AREA_REQUEST as described above. The use of these identifiers can be promoted, for example by charging lower fees or by increased priority in answering the messages.

Algorithm B—LAS knows the internal structure of the network:

Step 0

The message

LAP: UPDATE_LOCATION_AREA

as described above, also contains the internal structure of an area dealt with, a list of location areas and optionally also a list of radio cells.

Step 1

See algorithm A, step 1 above.

Step 2

See step 2 above In addition, a list of location areas and optionally also of radio cells is stored for each AREA_IDENTITY in the database.

Steps 3 and 4

See step 3 and step 4 above Naturally, these functionalities can also be physically integrated in the MSC-SGSN.

D. Dynamic Optimization in the Case of a Large Number of Clients

The network receives different independent inquiries for different areas from different independent applications located on many external clients. If the network deals with these inquiries independently of one another, it generates a large amount of superfluous traffic. The algorithm described is intended to lead to the expensive locating methods being executed only under certain conditions. It is then determined firstly whether the object is located in location areas, then in cells and it is only when the objected is located within a special cell that the actual locating is carried out.

Step 1

If it is found that a number of inquiries are made for the same area (this can be determined simply by finding the same AREA_IDENTITY in the inquiries during a comparison), the inquiry can be dealt with by the LAS itself. This is done either by using a result already reported back and temporarily stored in the cache or by waiting for a result already requested but not obtained. The probability of two identical inquiries from independent applications is very high when a large number of competitors offer the same services or the area is relatively large, for example a city.

Step 2

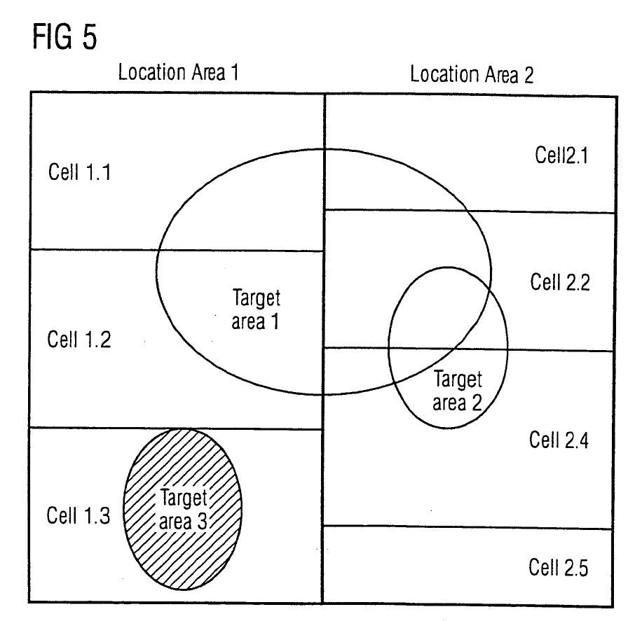

Even if two inquiries do not deal with absolutely identical areas, the algorithm used can still lead to the same location areas or cells. This concept can be clarified by the following example from FIG. 5. An area is shown which consists of two location areas, location area 1 and location area 2. These location areas, in turn, are divided into radio cells (cell 1.1, cell 1.2, cell 1.3, cell 2.1 etc.). There are various applications which make inquiries in three target areas which partially overlap both the location areas and the radio cells. In this case, there is only a small overlapping area between target area 1 and target area 2. Target area 1 covers location area 1 and location area 2, target area 2 only covers a part of location area 2 and target area 3, in turn, only covers location area 1. If an inquiry for target area 1 is received, this result can also be used later without any further inquiry for target area 2 and target area 3, respectively, without again requesting information from this MSC. For target area 1, the cells cell 2.1, cell 2.2 and cell 2.4 must be requested. These results can be used again later for target area 2.

An algorithm could look as follows:

Step 1

After receiving an instruction

LAP: AREA_REQUEST

the requested area is compared with those which were ended shortly before or the inquiry of which has not been completely processed yet. If agreements are found during the comparison, the request just received is answered from the answers already stored or delayed until the result is available. It must be taken into consideration that there can be different parameters in the inquiry such as “quality of service” parameters and accuracy of the inquiry.

Step 2

After receiving a list of selected network nodes as already described in part A, step 3, or the list of location areas or cells as described in part C, algorithm B, the LAS can break down the inquiry into a set of individual operations for subareas. For each subarea, the inquiry is dealt with as previously described in step 1. Subareas for which there is no result are collected and the inquiries are then forwarded to the GMLCs as already described above.

Step 3

The incoming results of the new inquiries are stored in the cache, together with a timestamp. As soon as all required information necessary for answering the original inquiry has been collected, an answer is generated together with the results from the cache. Optionally, partial results can also be sent immediately to the external client. This improves the response times, at least for a part, and distributes the load over time.

The second step can be improved further by means of the described architecture and databases in the LAS: If the inquiry AREA_REQUEST allows even answers with greater inaccuracy to be sent back or else with location information, the timestamp of which is further in the past, LAS can use the results of earlier inquiries for responding. This lowers the number of inquiries which must be forwarded to the GMLC.

The knowledge of the internal structure of various network operators can also lower the network load.

### EXAMPLE 1

A roaming subscriber outside his home network can alternatively register in two visited networks VPLMN1 and VPLMN2. If the LAS accurately knows the position of the subscriber in VPLMN1 and shortly thereafter there is an inquiry for VPLMN2, the subscriber has changed to VPLMN2 in the meantime and only this fact is known to the LAS, the current position can also be calculated with the required quality from the exact position from VPLMN1, the time difference and the average speed of the subscriber without having to carry out a new and more precise location inquiry from the second visited network VPLMN2.

### EXAMPLE 2

For this purpose, FIG. 3 must be considered again. If it is known that the location had been in network node 1 some time ago and an average speed does not allow the subscriber to be located already in the network node 3 area, an inquiry for this can be avoided. Using algorithms which take into consideration some past positions of the subscriber, the accuracy can also be enhanced without interrogating the networks. Some algorithms are described in the document by Lance Doherty et al. already cited above.

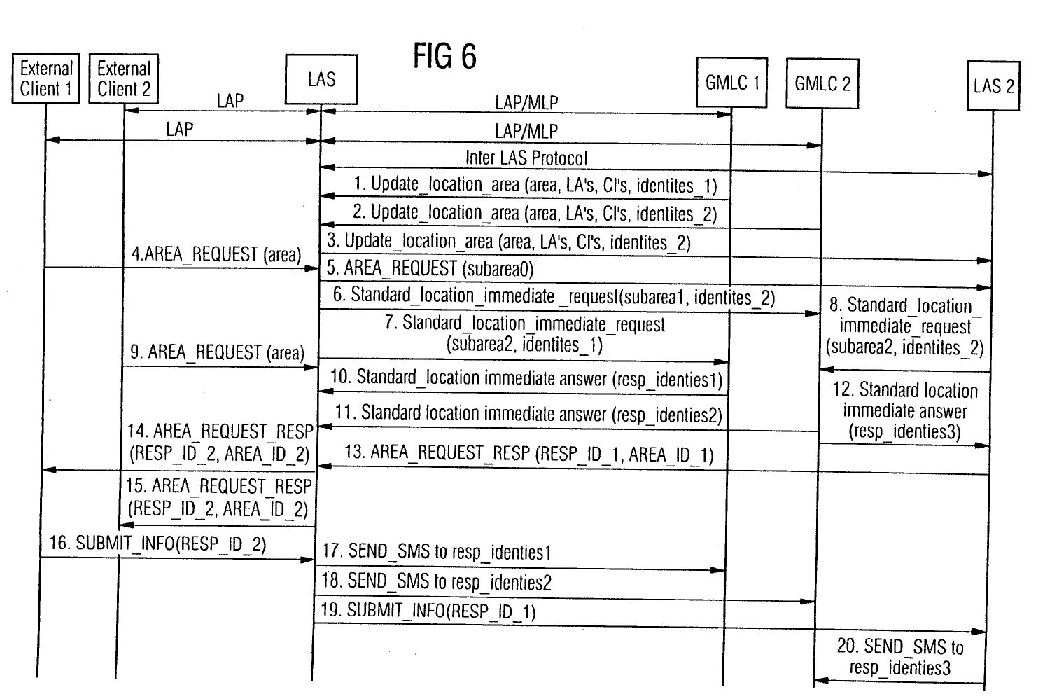

FIG. 6 contains a summary of the algorithms. The call-up diagram is only exemplary of some aspects of the invention and it is not complete, either, since some necessary response messages have been left out. It shows a location information server LAS, two application programs external client 1 and 2 with which the LAS communicates via the LAP protocol, two networks with the network elements GMLC1 and GMLC2 with which the location information server communicates via the LAP-MLP protocol and a second location information server LAS2 with which the first LAS communicates via an inter-LAS protocol. Both of the two independent application protocols want to send an SMS to all subscribers in the same region. This region is served by the two independent networks represented by GMLC1 and GMLC2.

Messages 1 and 2:

GMLC1 and GMLC2 send their location information coordinates of the areas for which they are responsible and optionally the structure and location of the location areas and radio cells to the LAS. In addition, the message can contain a structure of the identities and/or a list of currently active identities in this area.

Message 3:

The LAS is not responsible for a part of the location of GMLC2 which is why the corresponding part of the information is forwarded to LAS2 in a message. This does not appear to be optimal in this small network configuration but it does indicate the flexibility of the protocol.

Message 4:

The external client 1 sends an AREA_REQUEST to the LAS, containing a description of the requested area.

Message 5:

A part of this requested area (subarea 0) is not handled by the LAS but by the second location server LAS2. This request is, therefore, forwarded to LAS2.

Message 6:

A standard MLP protocol message as described in OMA is sent to GMLC2. It contains the subarea 1 served by GMLC2, and the identities used by GMLC2.

Message 7:

The same applies to GMLC1.

Message 8:

The location server LAS2, too, now sends standard MLP protocol messages for the area served by it and GMLC2 to GMLC2.

Message 9:

The second external client 2, too, now sends a location request AREA_REQUEST for the same area as in message 4. The location server LAS takes note of this fact and delays the processing of this message since it is waiting for the answers to the first inquiry (message 4).

Message 10:

The location server receives the answers from GMLC1. They may contain a long list of identities and their location information or error messages. This answer is stored until all requested information has arrived or until a timeout occurs.

Message 11:

The same applies to GLMC2.

Message 12:

The second location server LAS2, too, is collecting information.

Message 13:

The second location server LAS2 generates a temporary identity RESP_ID_1 for the collected subscriber identities and an identifier AREA_ID_1 for this area for later use. These are sent to the location server LAS.

Message 14:

The location server LAS now has all the necessary information, it also generates a temporary identity RESP_ID_2 and an identifier AREA_ID_2 for this area for later use. These are sent to the first external client 1.

Message 15:

The location inquiry AREA_REQUEST can now also be answered by the external client 2. Only information collected by the first inquiry from the external client 1 is used.

Message 16:

The external client 1 now wants to send a short SMS message to all subscribers located within the area specified before. It therefore sends a SUBMIT_INFO message with the text of the SMS to the location server LAS to the list stored there with the identity RESP_ID_2.

Message 17:

The location server LAS will send the text of this short SMS message to all subscriber identities which it has previously stored from GLMC1. In this case, the target is normally not the GLMC but a network node which is responsible for short messages.

Message 18:

The same applies to GMLC2.

Message 19:

The information is now also sent to location server 2 LAS2 by means of SUBMIT_INFO, using RESPOND_ID_1.

Message 20:

Location server 2 LAS2 will also proceed as described in message 17 above.

This application claims the priority under 35 U.S.C. § 119 of German patent application No. 103 15 064.1, filed Apr. 2, 2003. The disclosure of the priority application is herewith incorporated by reference in its entirety. MPEP 2163.07 (E8, 2003).

I claim:

1. A method for handling a location-based service in a limited geographic area for a plurality of subscribers, wherein the limited geographic area is served by at least two devices for determining a geographic position of mobile radio users, the method which comprises:
receiving, in a central network element, an inquiry from the location-based service concerning an identity of the subscribers in the limited geographic area;
requesting, with the central network element, a current information item about the subscribers active in the limited geographic area from the at least two devices for determining the geographic position of mobile radio users; and
delivering, with the central network element, the information to the location-based service.

2. The method according to claim 1, wherein a first device for determining the geographic position of mobile radio users is located within an infrastructure of a first mobile radio network and a second device for determining the geographic position of mobile radio users is located within an infrastructure of a second mobile radio network.

3. The method according to claim 1, which comprises, upon receiving an inquiry in the central network element, checking whether a desired result is already stored as a result of a previous inquiry and the result can be delivered to the location-based service, or the central network element must request the desired result from the at least one device for determining the geographic position of mobile radio users.

4. The method according to claim 3, which comprises providing a result requested by the central network element from a device for determining the geographic position of mobile radio users with an additional identification, and reusing the stored result for one or more further inquiries in dependence on the additional identification.

5. The method according to claim 1, which comprises, upon receiving an inquiry in the central network element, first checking whether a desired inquiry has already been processed or a result of a previous inquiry is still outstanding, and, after receiving the result of the previous inquiry, a current inquiry can also be answered.

6. The method according to claim 5, which comprises providing a result requested by the central network element from a device for determining the geographic position of mobile radio users with an additional identification, and reusing the stored result for one or more further inquiries in dependence on the additional identification.

7. The method according to claim 6, wherein the additional identification is at least one element selected from the group consisting of a timestamp and information on an accuracy of the inquiry.

8. The method according to claim 1, which comprises causing the central network element to collect the results of the inquiries from the at least two devices for determining the geographic position of mobile radio users and, as soon as all interrogated devices for determining the geographic position of mobile radio users have answered, to combine the answers and to deliver the result to the location-based service.

9. The method according to claim 1, wherein the inquiry is defined to cover:
a first geographic region for which a first central network element is responsible;
a second geographic region for which a second central network element is responsible; and
the first central network element receives an inquiry and forwards the inquiry for the second geographic region to the second central network element.

10. The method according to claim 1, which comprises storing results of inquiries as a list in the central network element and delivering only an identification of the list back to the location-based service.

11. The method according to claim 10, which comprises receiving or determining with the central network element characteristics of the subscribers determined from the devices for determining the geographic position of mobile radio users, collecting and storing the characteristics for later use, and delivering the characteristics back to the location-based service together with the identification of the list.

12. The method according to claim 1, wherein the central network element contains a correlation between the identity of at least one subscriber for whom a location information is requested and the network node responsible for the subscriber and, when the central network element receives an inquiry message from the location-based service, the central network element distributes the inquiry to each identity stored for the network node.

13. A method of providing location-based services within a limited geographic area to a plurality of subscribers, which comprises:
transmitting an inquiry from a location-based service to a central network element concerning an identity of the subscribers in the limited geographic area;
requesting information concerning the identity of the subscribers in the limited geographic area from at least two devices serving the limited geographic area for determining a geographic position of mobile radio users;
receiving a current information item in the central network element from the at least two devices for determining the geographic position of mobile radio users, about the subscribers active in the limited geographic area; and
forwarding the information from the central network element to the location-based service, and providing the location-bases services to the subscribers in the limited geographic area.

14. A device for handling inquiries of a location-based service for a limited geographic area served by at least two devices for determining a geographic position of mobile radio users, for a plurality of subscribers in the limited geographic area, comprising:
means for receiving inquiries, sent by the location-based service, about an identity of subscribers in the limited geographic area;
means for sending a request for current information about the subscribers active in the limited geographic area to a device for determining the geographic position of mobile radio users;
means for receiving responses from the interrogated device for determining the geographic position of mobile radio users;
means for processing the responses to form an inquiry result; and
means for sending the inquiry result to the location-based service.

15. The device according to claim 14, which further comprises:
means for storing the responses from the interrogated device for determining the geographic position of mobile radio users and an additional identification of the responses; and
means for comparing a new inquiry with the responses already stored.

16. The device according to claim 14, which further comprises:
means for storing the responses from the interrogated device for determining the geographic position of mobile radio users and sending an unambiguous identification of the responses; and
means for using the unambiguous identification of the answers in subsequent messages from the location-based service.
